(19) United States
(12) Patent Application Publication
(10) Pub. No.: US 2013/0073904 A1
(43) Pub. Date: Mar. 21, 2013

(54) SYSTEM AND METHOD FOR MANAGING TEST OF BASEBOARD MANAGEMENT CONTROLLER

(71) Applicants: CHIN-JUI HSU, Tu-Cheng (TW); YA-HUI KAO, Tu-Cheng (TW)

(72) Inventors: CHIN-JUI HSU, Tu-Cheng (TW); YA-HUI KAO, Tu-Cheng (TW)

(73) Assignee: HON HAI PRECISION INDUSTRY CO., LTD., Tu-Cheng (TW)

(21) Appl. No.: 13/535,493

(22) Filed: Jun. 28, 2012

(30) Foreign Application Priority Data
Sep. 21, 2011 (TW) 100133864

(51) Int. Cl. G06F 11/28

(52) U.S. Cl. 714/27; 714/E11.178

(57) ABSTRACT

A baseboard management controller (BMC) server connects to an electronic device. The electronic device includes a BMC. The BMC server stores test instructions of test items of the BMC. If a user selects test items of the BMC, the BMC server download the corresponding test instructions to the electronic device. The electronic device executes the test instructions and acquires test results. If the test results accord with standard test results of the test items, the BMC server prompts that tests of the test items pass. If the test results do not accord with the standard test results of the test items, the BMC server determines that the tests of the test items fail.

### BACKGROUND

1. Technical Field

Embodiments of the present disclosure relate to test management systems and methods, and particularly to a system and a method for managing a test of a baseboard management controller (BMC).

2. Description of Related Art

A plurality of electronic devices (like servers, computers) include baseboard management controllers (BMC). If users want to test the electronic devices, it is very important to test the BMC. Presently, a test of the BMC and analysis of test results are performed manually. If the BMC has a large number of test items, the analysis of the test results may be error-prone because of users' carelessness.

### BRIEF DESCRIPTION OF THE DRAWINGS

FIG. 1 is a block diagram of one embodiment of a baseboard management controller server comprising a management system.

FIG. 2 is a block diagram of one embodiment of the function modules of the management system in FIG. 1.

FIG. 3 is a flowchart illustrating one embodiment of a method for managing test of a baseboard management controller.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

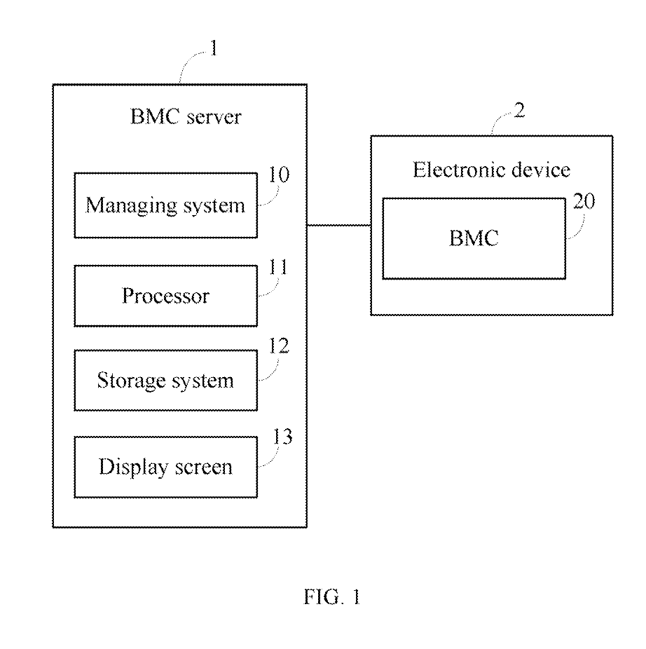

FIG. 1 is a block diagram of one embodiment of a baseboard management controller (BMC) server 1 including a management system 10. The BMC server 1 is electronically connected to at least one electronic device 2. In some embodiments, the electronic device 2 may be a computer or a server. The electronic device 2 includes a BMC 20. The BMC server 1 provides an interface displayed on a display screen 13 for a user. The user can select test items of the BMC 20 of each electronic device 2 from the interface.

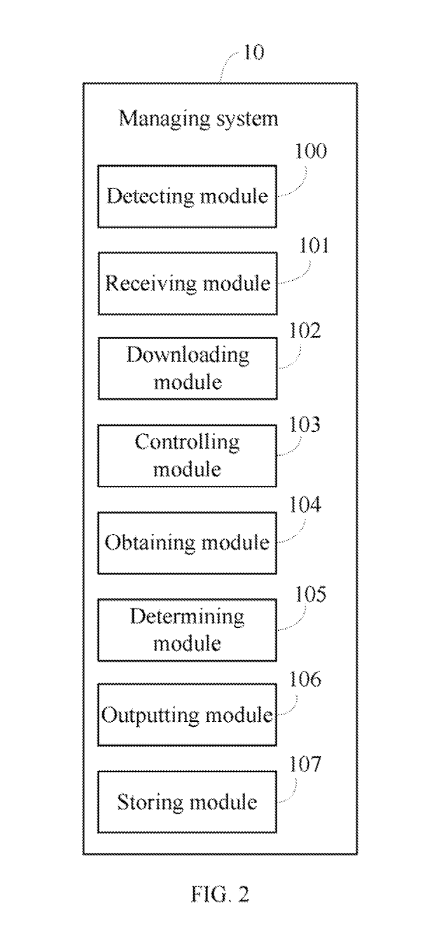

In an exemplary embodiment, the BMC server 1 further includes at least one processor 11 and a storage system 12. The management system 10 may include one or more modules (described in FIG. 2). The one or more modules may comprise computerized code in the form of one or more programs that are stored in the storage system 12 (or memory). In one embodiment, the storage system 12 may be a magnetic, an optical, or other suitable storage medium. The computerized code includes instructions that are executed by the at least one processor 11 to provide functions for the one or more modules described below. The storage system 12 stores an intelligent platform management interface specification (IPMI Spec) and test instructions for testing the BMC 20. The test instructions can test all the test items of the BMC 20. Different electronic devices 2 may correspond to different test instructions. The storage system 12 includes a public pool and a plurality of private pools. The public pool stores common test instructions for all the electronic devices 2. Each private pool stores particular test instructions for an appointed electronic device 2.

As shown in FIG. 2, the management system 10 includes a detection module 100, a receiving module 101, a downloading module 102, a controlling module 103, an obtaining module 104, a determining module 105, an outputting module 106, and a storing module 107.

The detection module 100 detects if the test items of an electronic device 2 exist in the storage system 12. In one embodiment, the interface may display all the test items stored in the storage system. The interface may also provide an inputting item for the user to input the test items that are not stored in the storage system 12. If the test items of the electronic device 2 do not exist in the storage system 12, the user may select the inputting item.

In response that the detection module 100 detects the selection of the inputting item, the receiving module 101 prompts the user to input test item information, and stores the test item information into the storage system 12. In one embodiment, the test item information may include test items and standard test results of the test items. The receiving module 101 may store the test item information into the private pool corresponding to the electronic device 2.

If the test items of the electronic device 2 exist in the storage system 12, the downloading module 102 downloads the test instructions corresponding to the test items to the electronic device 2. In one embodiment, before downloading the test instructions, the downloading module 102 searches for the test instructions corresponding to the test items in the storage system 12. The downloading module 102 may first search for the test instructions in the public pool. If the test instructions cannot be found in the public pool, the downloading module 102 searches for the test instructions in the private pool corresponding to the electronic device 2.

The controlling module 103 controls the electronic device 2 to execute the downloaded test instructions according to the IPMI Spec and acquire test results corresponding to each test item.

The obtaining module 104 obtains the test results of all the test items from the electronic device 2.

The determining module 105 detects if the test results accord with the corresponding standard test results. In one embodiment, if the test results are the same as the corresponding standard test results, the determining module 105 may determine that the test results accord with the corresponding standard test results. In another embodiment, the determining module 105 determines that a test result accord with a corresponding standard test result when a difference between the test result and the standard test result is within a predefined range.

If the test results accord with the corresponding standard test results, the outputting module 106 prompts that the BMC 20 has passed the test. If the test results do not accord with the corresponding standard test results, the outputting module 106 prompts that the BMC 20 has failed the test. In one embodiment, the display screen 13 may display a window for prompting the user of the test results.

The storing module 107 stores all the test results in the storage system 12.

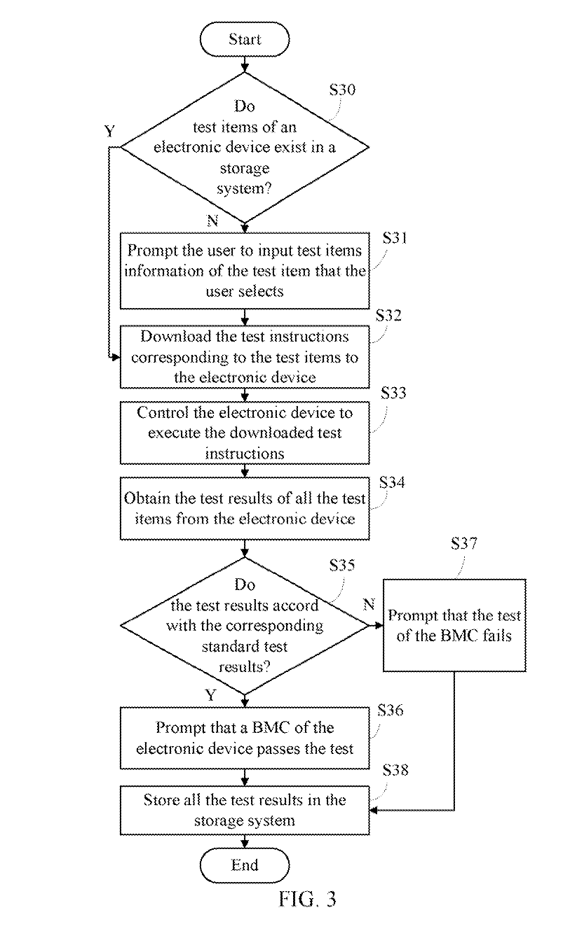

FIG. 3 is a flowchart illustrating a method for managing test of the BMC 20 of the electronic device 2. Depending on the embodiment, additional steps may be added, others removed, and the ordering of the steps may be changed.

In step S30, the detection module 100 detects if the test items of an electronic device 2 exist in the storage system 12. If the test items of the electronic device 2 do not exist in the storage system 12, step S31 is implemented. If the test items of the electronic device 2 exist in the storage system 12, step S32 is implemented.

In step S31, the receiving module 101 prompts the user to input test items information and stores the test items information into the storage system 12.

In step S32, the downloading module 102 downloads the test instructions corresponding to the test items to the electronic device 2. The downloading module 102 searches for the test instructions corresponding to the test items in the storage system 12, and then downloads the test instructions. The downloading module 102 may search for the test instructions in the public pool at first. If the test instructions cannot be searched in the public pool, the downloading module 102 searches for the test instructions in the private pool corresponding to the electronic device 2.

In step S33, the controlling module 103 controls the electronic device 2 to execute the downloaded test instructions according to the IPMI Spec and acquire test results corresponding to each test item.

In step S34, the obtaining module 104 obtains the test results of all the test items from the electronic device 2.

In step S35, the determining module 105 detects if the test results accord with the corresponding standard test results. If the test results accord with the corresponding standard test results, step S36 is implemented. If the test results do not accord with the corresponding standard test results, step S37 is implemented.

In step S36, the outputting module 106 prompts that the BMC 20 has passed the test.

In step S37, the outputting module 106 prompts that the test of the BMC 20 has failed.

In step S38, the storing module 107 stores all the test results in the storage system 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A baseboard management controller server, comprising:
a storage system;
at least one processor; and
one or more programs being stored in the storage system and executable by the at least one processor, the one or more programs comprising:
a receiving module receives test items of a baseboard management controller (BMC) of an electronic device that is electronically connected to the BMC server;
a downloading module downloads test instructions corresponding to the test items to the electronic device from the storage system;
a controlling module controls the electronic device to execute the downloaded test instructions and acquire test results from the electronic device; and
a storing module stores the test results in the storage system.

2. The baseboard management controller server as described in claim 1, wherein the receiving module further receives standard test results of the test items input by a user and stores the standard test results in the storage system.

3. The baseboard management controller server as described in claim 2, wherein the one or more programs further comprises:
a determining module detects whether the test results accord with the corresponding standard test results; and
an output module prompts that the BMC of the electronic device passes the test when the test results accord with the corresponding standard test results, and prompts that the test of the BMC of the electronic device fails when the test results do not accord with the corresponding standard test results.

4. A computer-based method for managing test of baseboard management controller, comprising:
receiving test items of the baseboard management controller (BMC) of an electronic device connected to a BMC server;
downloading test instructions corresponding to the test items to the electronic device from the BMC server;
controlling the electronic device to execute the downloaded test instructions and acquire test results from the electronic device; and
storing the test results in a storage system of the BMC server.

5. The method as described in claim 4, further comprising:
receiving standard test results of the test items input by a user and stores the standard test results in the storage system.

6. The method as described in claim 5, wherein the method before the storing step further comprising:
detecting whether the test results accord with the corresponding standard test results; and
prompting that the BMC of the electronic device passes the test when the test results accord with the corresponding standard test results; and
prompting that the test of the BMC of the electronic device fails when the test results do not accord with the corresponding standard test results.

7. A non-transitory storage medium having stored thereon instructions that, when executed by a processor, cause the processor to perform a method for managing test of baseboard management controller, the method comprising:
receiving test items of the baseboard management controller (BMC) of an electronic device connected to a BMC server;
downloading test instructions corresponding to the test items to the electronic device from the BMC server;
controlling the electronic device to execute the downloaded test instructions and acquire test results from the electronic device; and
storing the test results in a storage system of the BMC server.

8. The non-transitory storage medium as described in claim 7, further comprising:
receiving standard test results of the test items input by a user and stores the standard test results in the storage system.

9. The non-transitory storage medium as described in claim 8, wherein the method before the storing step further comprising:
detecting whether the test results accord with the corresponding standard test results; and
prompting that the BMC of the electronic device passes the test when the test results accord with the corresponding standard test results; and
prompting that the test of the BMC of the electronic device fails when the test results do not accord with the corresponding standard test results.
